(19) United States
(12) Patent Application Publication
(10) Pub. No.: US 2009/0025506 A1
(43) Pub. Date: Jan. 29, 2009

(54) Vehicle Pedal Controls proof against Misapplication of Accelerator

(76) Inventor: Boris Karpachev, Auburndale, MA (US)

Correspondence Address: BORIS KARPACHEV, 535 AUBURN ST., APT. 2, AUBURNDALE, MA, 02466, US

(21) Appl. No.: 11/829,868

(22) Filed: Jul. 27, 2007

(51) Int. Cl. G05G 1/14; G05G 1/16; G05G 5/00

(52) U.S. Cl. 74/513; 74/527; 74/562.5

(57) ABSTRACT

Vehicle Pedal Controls proof against Misapplication of Accelerator allows inversion-eversion operation of the acceleration pedal by the driver's foot for the better driver's distinction of the operation of the acceleration pedal from that of the brake pedal. And any of the invented vehicle control pedals, operable whether downward or transversely or inverse-eversely, provides for the braking of the vehicle with the strong push down of any pedal, whether the accelerator or the brake one,—that prevents the misapplication of the accelerator. In many embodiments of the invention, the pedal comprises the first part being impacted directly by the driver's foot, the last part being connected directly to the appropriate device of the vehicle (brakes or engine) and the detent holding said first part in mechanical relation to said last part, wherein said detent may be disengaged, for example, at misapplication of the acceleration pedal or certain other condition.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO JOINT RESEARCH AGREEMENT

Not Applicable.

### INCORPORATION-BY-REFERENCE OF MATERIAL SUBMITTED ON A COMPACT DISC

Not Applicable.

### BACKGROUND OF THE INVENTION

1. Field of the Invention

The invention relates generally to the motor vehicles with means for promoting safety of vehicle, its occupants or load, or an external object, and more specifically to the vehicle control pedals proof against driver's misapplication of the vehicle acceleration pedal.

People enjoy the vehicles, which are safe and give predictable response when driven correctly by the operator being in stable mental and physical condition and/or on a safe road and/or in safe situation. But sometimes, the operator intending to slow down or stop the vehicle actually depresses mistakenly the accelerator instead of the brake pedal, or depresses the accelerator excessively fast when being on a slippery or dangerous road, or the operator is a car thief neglecting safe driving—said situations may result in essential damage, including death. Hence, there is a need for means against misapplication of the accelerator. This invention provides for making and using the vehicle pedal controls proof against the misapplication of the accelerator.

2. Description of Related Arts

In general, a vehicle pedal controls, as the brake pedal, as the accelerator, are downward operable. Therefore, if a driver willing to slow down his/her vehicle steps mistakenly on a pedal, which he/she thinks being the brake pedal, but it is an accelerator actually, then his/her vehicle starts accelerating. Unexpectedness of the acceleration emotionally shocks the driver. Instinctively trying to slow down his/her vehicle he/she steps on the pedal harder, as he/she continues to believe he/she steps on the brake pedal. In response, the vehicle accelerates faster, because he/she continue to step actually on the accelerator but the brake pedal. Not every driver, especially elderly one, is able to realize and correct the mistake enough fast. Such a misapplication of an accelerator instead of a brake pedal is extremely dangerous even deadly often.

There are known vehicle pedal controls with the improved safety of use. Nevertheless, the problem of misapplication of the accelerator continues to be topical, in particular because the number of elderly drivers is increasing.

U.S. Pat. No. 5,797,467 disclosures a device for preventing an accelerator from being erroneously operated, wherein the magnetic coupling means are placed between an accelerator pedal and a throttle valve and said means are so magnetically set that they may be disconnected by the pedaling force at the erroneous operation.

U.S. Pat. No. 7,181,991 disclosures an automobile accelerator and brake pedal device comprising a vertically operable brake pedal and a transversely operated accelerator pad mounted on the brake pedal, wherein in a first position of the brake pedal the accelerator works, but the accelerator is irresponsive in the second depressed position of the brake pedal.

U.S. Pat. No. 5,193,640 disclosures a safety system for use in a motor vehicle comprising an accelerator having a first working position and a second position beyond the first working position, wherein a speed control device reduces a motor speed when the accelerator is in the second position.

But, the known vehicle safety devices or systems intended to prevent the misapplication of the accelerator do not provide for sufficient decision of the problem. It is difficult to add any such a device to already existing vehicle, for example, to those of elderly drivers, therefore they are not widely adopted, and thus, they do not decide the existing problem of the misapplication of the accelerator. Therefore there is an urgent need for continuing the search for more successful preventing the misapplication of the acceleration pedal.

As the strong push a pedal down is typical of the misapplication of the accelerator, then said strong push down applied to any pedal, either the brake one or the accelerator, has to engage the vehicle's brakes. Also, the driver's foot anatomical motion and corresponding muscular feeling of operating the accelerator should be more distinctive from that of operating the brake pedal.

In these respects, the Vehicle Pedal Controls proof against Misapplication of Accelerator according to the present invention substantially depart from the conventional concepts and designs of the prior art, and provide for the Vehicle Pedal Controls which are enough simple and easier to add to the vehicles existing already.

### BRIEF SUMMARY OF THE INVENTION

Vehicle Pedal Controls proof against Misapplication of Accelerator are for the operation by a driver's foot or feet and comprise a brake pedal, an acceleration pedal (also known as an accelerator or a gas pedal).

In some of the embodiments of the invention, an acceleration pedal is made suitable for the inversion-eversion operation by the driver's foot, what provides for better distinction in the driver's muscular feeling of operating the accelerator from that of operating the brake pedal and thus for less probable misapplication of the accelerator pedal instead of the brake one. Also for said better distinction, in other embodiments of the invention, an acceleration pedal is made suitable for the transverse operation. In all embodiments of the invention, with the strong push down of any pedal, either the accelerator or the brake one, the driver engages the brakes of the vehicle—that prevents misapplication of the accelerator.

In some embodiments of the invention, each of said pedals consists, at least, of two physical parts, namely, the first part and the last part, wherein the first part accepts the driver's foot operating impact and the last part transfers, at certain condition, said impact to the appropriate device of the vehicle, namely, to the engine or to the brakes, and wherein the first part related to the last part by detents or a detent, what is a device for positioning and holding with the resisting force one mechanical part in certain relation to another, when said device is engaged, so that said device can be released by the detaching force being stronger than said resisting force and applied to one of the parts or by a disengaging signal of electrical and/or mechanical nature.

Any detent may be mechanical or electrical one and of permanent or variable holding capacity. If electrical and variable, then the detent holding capacity may be controlled by means of electric current by the vehicle's central processing unit and/or electric controls. The first part and the detent or detents may be shared by the brake pedal and the accelerator. The detaching force arises from a misapplication of the accelerator. Or the force becomes detaching because of lowering the resisting force mechanically or electrically by the vehicle's central processing unit and/or electric controls. The disengaging signal either electrical or mechanical may be generated inside the vehicle and/or outside and transmitted inside the vehicle.

If the acceleration pedal detent is engaged, then said detent relate the first part of the acceleration pedal to the last part so, that the driver's foot operational impact transfers from the first part through the detent and further to the last part and to the engine of the vehicle. The last part may comprise a device damping and/or resisting and/or stopping transmitting the driver's foot operational impact for acceleration of the vehicle.

If the acceleration pedal detent is disengaged, then no transmitting of the driver's operating impact to the engine. The last part of the acceleration pedal cannot be operated directly by the driver's foot. The acceleration pedal detent is disengaged when the driver's foot operational impact is harmful but normal.

If the brake pedal detent is engaged, then it prevents transmitting the driver's operating impact from the first part of the brake pedal to the last part and further to the brakes. If the brake pedal detent is disengaged, then the driver's foot operational impact can be transferred from said first part to the last part of the brake pedal and further to the brakes of the vehicle. Also, the last part of the brake pedal can be operated by the driver's foot directly. The brake pedal detent is disengaged when the driver's foot operational impact is harmful but normal.

Any above-mentioned detent may be, for example, a catch, dog, or spring operated ball, or a permanent magnet and a coupling magnet or a coupling ferromagnetic detail, or an electromagnet and a coupling detail, or of adhesive nature and similar devices.

And any above-mentioned detent and/or damping and/or resisting and/or stopping device may be controlled by means of electric current by the vehicle's central processing unit and/or electric controls. A modern vehicle has more than one central processing unit optimizing the engine performance, generally known as engine control unit. Other central processing unit gathers and stores information related to safety and activates safety devices when necessary. Advanced driver assistance systems (containing a central processing unit) are promoting. The immobilizer is becoming the standard feature. So, one of the central processing units of the vehicle can or will be able soon to analyze the situation inside and/or outside the vehicle and/or receive the data on said situation from outside and correspondingly change by means of electric current the capacities of the above-mentioned detents, damping and/or stopping devices for improving the safety. Also, said analysis of safety may be made a person sitting next to the driver, and said person can intervene for improving the safety with mechanical means and/or the electric controls to the above-mentioned detents, damping and/or stopping devices.

The improved, in accordance with the invention, vehicle pedal controls can be mounted in the space for driver's feet, and this way they may substitute for old ones in the vehicles existing already, including in those of elderly drivers.

Achieving the above and related objects, this invention may be embodied in the constructions illustrated in drawings. However, the drawings are illustrative only, and changes within the scope of the claims may be made in any specific construction illustrated.

### BRIEF DESCRIPTION OF THE SEVERAL VIEWS OF THE DRAWINGS

FIG. 1 is the view from above of the assembly of a brake pedal and an acceleration pedal, wherein the acceleration pedal is made suitable for the inversion-eversion operation by the driver's foot and the brakes may be engaged directly by stepping on the brake pedal or indirectly by rotating eversely the acceleration pedal or by stepping on the acceleration pedal, as the shaft of the acceleration pedal is springy one.

FIG. 2 is the view from above of the assembly of a brake pedal and an acceleration pedal, wherein the acceleration pedal is made suitable for the inversion-eversion operation by the driver's foot and the brakes may be engaged directly by stepping on the brake pedal or indirectly by stepping on the acceleration pedal, as the shaft of the acceleration pedal is springy mounted one.

FIG. 3 is the view from above of the assembly of a brake pedal and an acceleration pedal downward operable, wherein the pedals share a first part and a detent and wherein the brakes may be engaged directly by stepping on the brake pedal or indirectly by deeply stepping on the acceleration pedal.

FIG. 4 is the view from above of the assembly of a brake pedal and an acceleration pedal, wherein each pedal consists of two parts related by a detent and wherein the acceleration pedal is transversely operable and wherein the brakes may be engaged directly by stepping on the brake pedal or indirectly by firmly stepping on the brake pedal first part, which serves as the support for the driver's foot at transverse operation of the acceleration pedal.

FIG. 5 is the lateral view of the shared detent of the pedal assembly shown in FIG. 3, FIG. 13 and FIG. 14. The detent consists of two parts mutually arresting each other with the resisting force which may be overcome by the bigger detaching force. The upper part is permanently and flexibly attached to the acceleration pedal last part. The lower part is permanently attached to the first part shared by the brake pedal and the acceleration one.

FIG. 6 is the lateral view of the brake pedal detent of the pedal assembly shown in FIG. 4, FIG. 12 and FIG. 11 (modified version). The detent consists of two parts mutually arresting each other. The upper part is an electromagnet with electric current regulated via an electric cable. The upper part is permanently and flexibly attached via a frame to the floor. The lower part is permanently attached to the brake pedal first part.

FIG. 7 is the lateral view of the stopping device shown in FIG. 2, FIG. 3 and FIG. 14.

FIG. 8 is the lateral view of the return spring shown in FIG. 2, FIG. 3, FIG. 4, FIG. 11, FIG. 12, FIG. 13 and FIG. 14.

FIG. 9 is the lateral view of the stopping device shown in FIG. 4.

FIG. 10 is the lateral view of the stopping device shown in FIG. 3, FIG. 11, FIG. 13 and FIG. 14.

FIG. 11 is the view from above of the assembly of a brake pedal and an acceleration pedal suitable for the inversion-eversion operation by the driver's foot, wherein the first part and the last part of the acceleration pedal is made coaxially rotating around an axis approximately parallel to the body of the brake pedal. The brakes may be engaged directly by stepping on the brake pedal or indirectly by firmly stepping on the acceleration pedal.

FIG. 12 is the view from above of the assembly of a brake pedal and an acceleration pedal, wherein the first part and the last part of the acceleration pedal is made coaxially rotating around an axis approximately parallel to the lever of the brake pedal and wherein the acceleration pedal is transversely operable though rotating around said axis. The brakes may be engaged directly by stepping on the brake pedal or indirectly by firmly stepping on the brake pedal first part, which serves as the support for the driver's foot at transverse operation of the acceleration pedal.

FIG. 13 is the view from above of the assembly of a brake pedal and an acceleration pedal downward operable, wherein the pedals share a first part and a detent, and wherein the first part becomes mechanically connected via the lever to the last part of the brake pedal after the detent has been disengaged and wherein the brakes may be engaged directly by stepping on the brake pedal or indirectly by deeply stepping on the acceleration pedal.

FIG. 14 is the view from above of the assembly of a brake pedal and an acceleration pedal downward operable, wherein the pedals share a first part and a detent and wherein the brakes may be engaged directly by stepping on the brake pedal or indirectly by deeply stepping on the acceleration pedal and also indirectly by pulling back the emergency handle.

### DETAILED DESCRIPTION OF THE INVENTION

Similar reference characters denote similar elements throughout the several views of the drawings, which illustrate preferred embodiments of the invention. Similar reference characters with primes affixed denote modifications of the similar elements.

With continue reference to the drawings, any embodiment of a Vehicle Pedal Controls proof against Misapplication of Accelerator comprises a brake pedal rigid body (1) rotating around an axis or fulcrum and the brake pedal platform (2) attached to said body to accommodate a driver's foot, wherein said body and platform are the brake pedal last part, which actuates brakes; a brake pedal first part (3); an acceleration pedal first part (4) with a platform attached to accommodate the driver's foot and an acceleration pedal last part (5), which causes acceleration of the vehicle. Any embodiment of the invention is intended to be mounted inside a vehicle, on the floor in the space for a driver's feet.

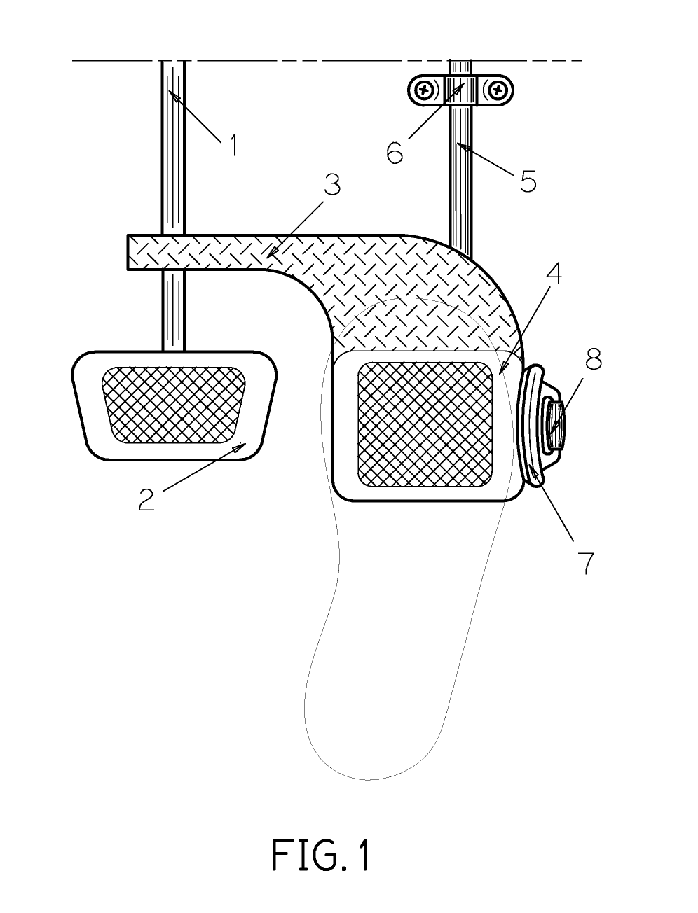

Referring to FIG. 1, the embodiment of the vehicle pedal controls is suitable for the inversion-eversion operation of the acceleration pedal and downward operation of the brake pedal by the driver's foot or feet. There is no detent in this embodiment, and an acceleration pedal is the whole entity. So, only imaginably the brake pedal first part (3), the acceleration pedal first part (4) with the platform attached and the acceleration pedal last part (5), which is carried out as the springy shaft rotating in the bearing (6), may be discerned. From the initial about-horizontal position, the inversion motion of the driver's right foot being on the platform (4) causes the clockwise rotating the acceleration pedal around the axes, which is parallel to the acceleration pedal last part (5), and, consequently, the acceleration of the vehicle. The eversion motion of the driver's right foot causes the counterclockwise rotating and, consequently, the platform, which is hang over the brake pedal body (1), pushes said body (1) down, what causes the braking of the vehicle. Stepping down onto the left half of the acceleration pedal platform (4), for example, at misapplication of the acceleration pedal, causes counterclockwise rotating and, consequently, the braking of the vehicle. The stopping ledge (7) attached to the platform (4) prevents the driver's foot from getting outside the platform's edge going down at inversion motion of the driver's foot, for example, during prolong driving. A roller (8) prevents the platform (4) getting stuck in the floor.

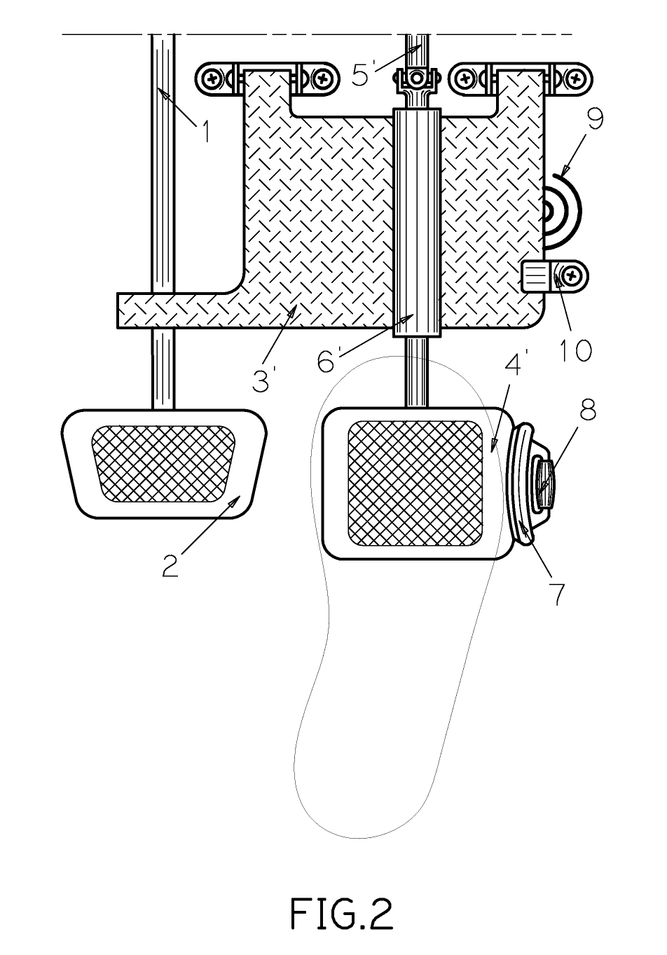

Referring to FIG. 2, the embodiment of the vehicle pedal controls is suitable for inversion-eversion operation of an acceleration pedal and downward operation of a brake pedal by the driver's foot or feet. There is no detent in this embodiment, and the acceleration pedal is the whole entity. So, only imaginably the acceleration pedal first part (4′) with the platform attached and the acceleration pedal last part (5′) may be discerned. But the brake pedal first part (3′) is real and springy mounted one. The return spring (9) pushes said first part (3′) upward but the stopping device (10) limits its upward advance. From the initial position, the clockwise rotating of the acceleration pedal platform (4′), around the axes approximately parallel to the acceleration pedal last part (5′), which is carried out as the shaft rotating in the bearing (6′), causes acceleration of the vehicle. Stepping down onto any platform (2) or (4′) or both ones causes the braking of the vehicle. The stopping ledge (7) attached to the platform (4′) prevents the driver's foot from getting outside the platform's edge going down at inversion motion of the driver's foot, for example, during prolong driving. A roller (8) prevents the platform (4′) getting stuck in the floor.

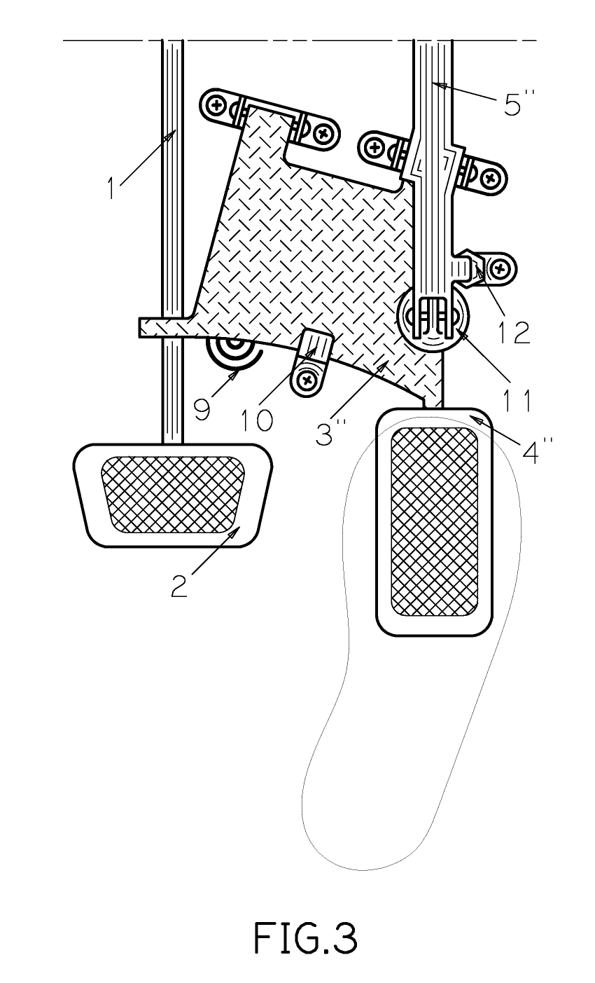

Referring to FIG. 3, the embodiment of the vehicle pedal controls is suitable for the downward operation of any of two pedals by the driver's foot or feet. The first part (3″) and the detent (11) are shared by both pedals. The first part (3″) is springy mounted with the return spring (9) and the stopping device (10). At normal operation, the first part (3″) does not contact the stopping device (12) and the body (1)—consequently, did not affect operation of the vehicle's brakes and accelerator. At normal operation, the detent (11) is engaged and the driver's downward push of the platform (4″), attached to the first part (3″), is transferred via the engaged detent (11) to the acceleration pedal last part (5″), what causes the acceleration of the vehicle. But, if said last part (5″) of the acceleration pedal is advanced via the detent (11) downward so deeply, that it has been stopped mechanically by the stopping device (12) and the detent (11) has been disengaged, then the acceleration pedal last part (5″) is returned into its starting position of the smallest acceleration by its return spring (not shown here). At said excessively deep advance, the brake pedal first part (3″), hanging over the body (1), starts transmitting the driver's push downward to the body (1) of the brake pedal and the vehicle's brakes start working. This way, if misapplication of the acceleration pedal, as the deep stepping down, has occurred, then acceleration of the vehicle stops and the brakes starts being applied via the first part (3″) shared by the brake pedal and the acceleration one.

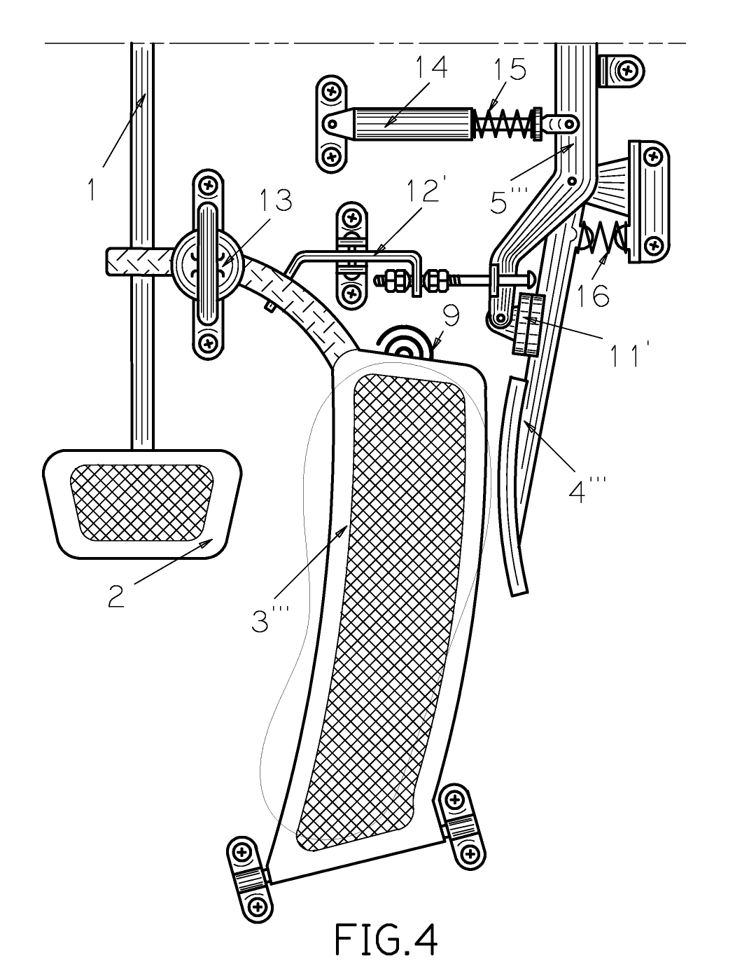

Referring to FIG. 4, the embodiment of the vehicle pedal controls is suitable for the downward operation of the brake pedal and the transverse operation of the acceleration pedal by the driver's foot or feet. The brake pedal detent (13) together with the return spring (9) keeps the brake pedal first part (3′″), loaded with the driver's foot, in the upper position, where the brake pedal first part (3′″), hanging over the body (1) of the brake pedal, does not contact said body (1) or the stopping device (12′). With pushing the acceleration pedal first part (4′″) to the right, the driver causes acceleration of the vehicle, as said first part (4′″) pulls, via the acceleration pedal detent (11′), the acceleration pedal last part (5′″), which directly connected to the throttle of the vehicle engine. But, excessively pushing the acceleration pedal first part (4′″) to the right causes disengagement of the acceleration pedal detent (11″) by the stopping device (12′) and return of the acceleration pedal last part (5′″) into its initial position of smallest acceleration. The damping device (14) together with the spring (15) resists the fast counterclockwise motion of the acceleration pedal last part (5′″) causing acceleration. And, if said motion is excessively fast, then said resisting is excessively strong, so the acceleration pedal detent (11′) disengages and the acceleration pedal last part (5′″) returns into its initial position of smallest acceleration. The damping device (14) together with the spring (15) does not resist the fast clockwise motion of the acceleration pedal last part (5′″) decreasing acceleration. Also, if the driver steps harder than usual on the brake pedal first part (3′″), then the brake pedal detent (13) disengages, consequently the brake pedal first part (3′″) hanging over the body (1) pushes downward said body (1) and engages the stopping device (12′), as a result, the vehicle brakes start working and the stopping device (12′) disengages the acceleration pedal detent (11′) and the acceleration pedal last part (5′″) returns into its initial position of smallest acceleration. But if released, then the acceleration pedal first part (4′″) is also returned into its initial position, by the return spring (16), consequently the acceleration pedal detent (11′) engages again. And, if the brake pedal first part (3′″) is released from the driver's foot pressure, then it is returned into its initial position by the spring (9) and the brake pedal detent (13) engages again, as well. In all, the pedal controls restore their efficiency immediately after the driver's foot has been removed.

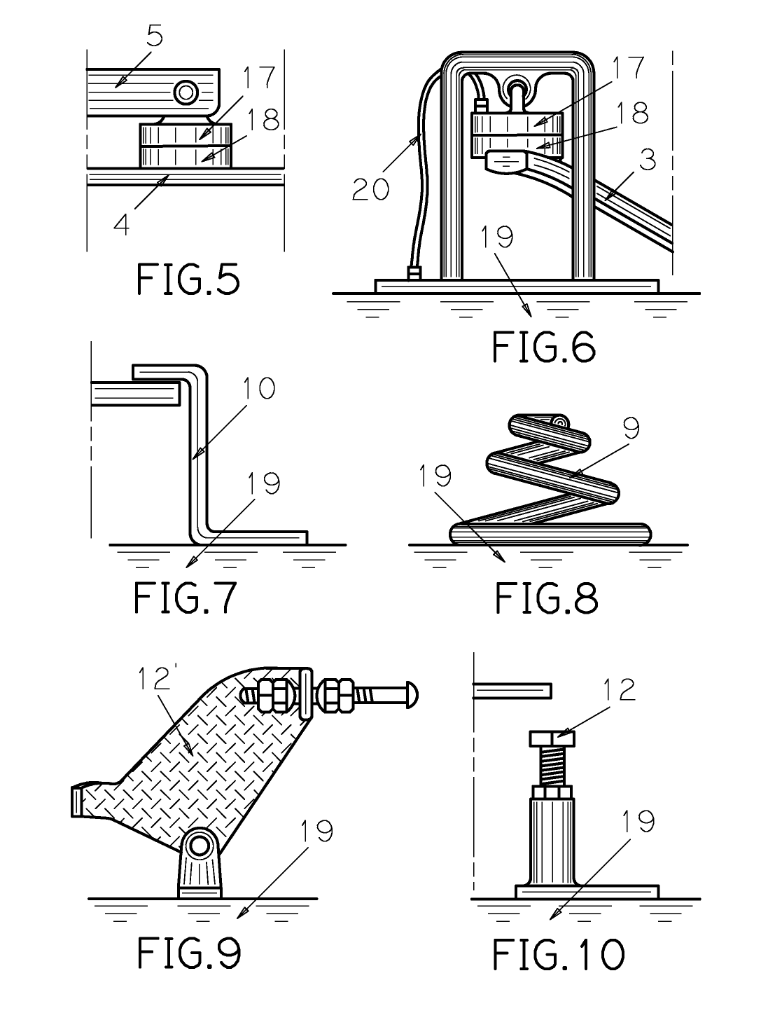

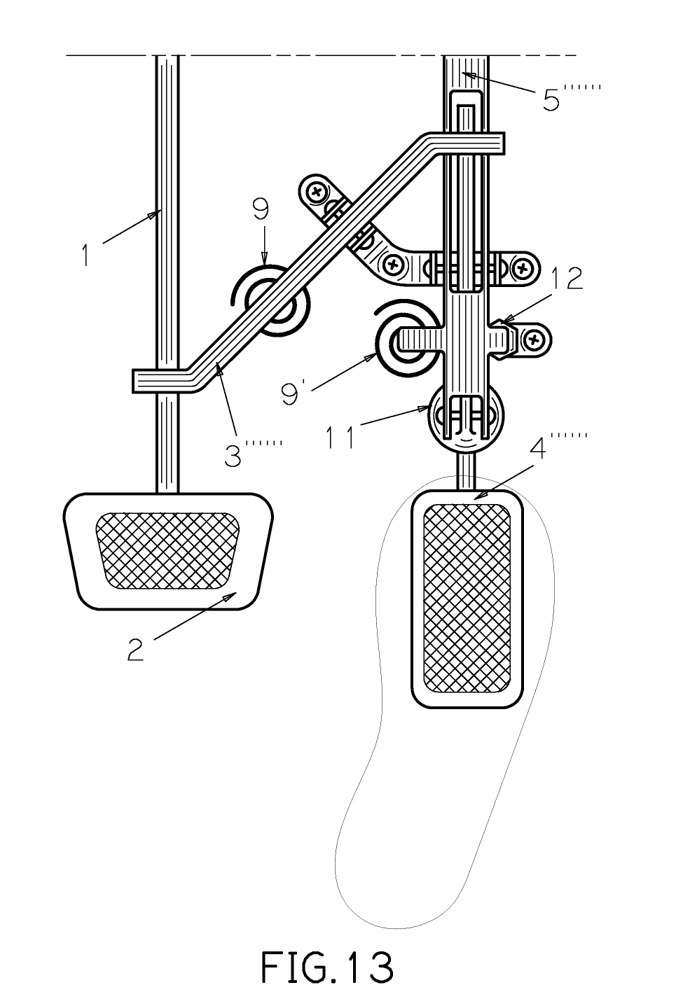

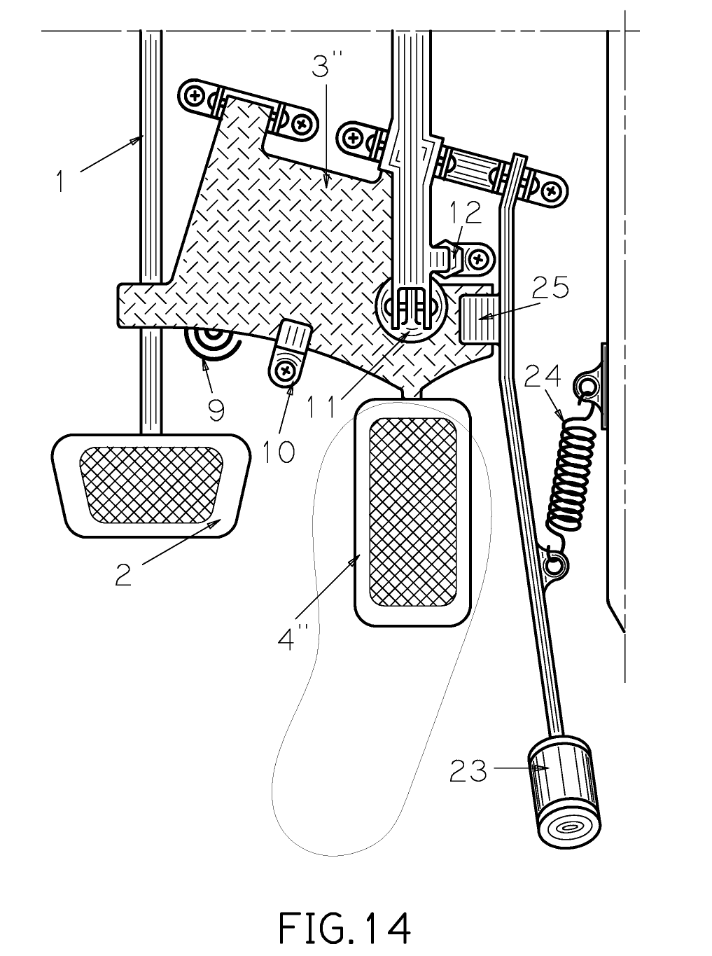

Referring to FIG. 5, the shared detent (11) of the pedal assembly shown in FIG. 3, FIG. 13 and FIG. 14 consists of two parts (17) and (18) mutually arresting each other with certain regulated or permanent resisting force, until said resisting force is overcome by stronger detaching force applied to the part (17) upward and the part (18) downward, when the parts (17) and (18) become gaped and free each from other. But if the parts (17) and (18) are brought enough close, they again arrest each other with the same resisting force. The part (17) is permanently and/or flexibly attached to the acceleration pedal last part (5) and the part (18) is permanently and/or flexibly attached to the first part (4) shared by the acceleration pedal and the brake pedal. The parts (17) and (18) both are mechanical details, for example, connected with an adhesive material or a spring-operated ball or a catch or a dog, or both are permanent magnets or electromagnets or one is a permanent magnet or electromagnet, whereas the other is made of ferromagnetic or paramagnetic material. If any detail of said two is the electromagnet, then it's electric current can be regulated by the vehicle's central processing unit and/or electric controls and/or the signal to release generated inside of the vehicle and/or outside it and transmitted inside the vehicle.

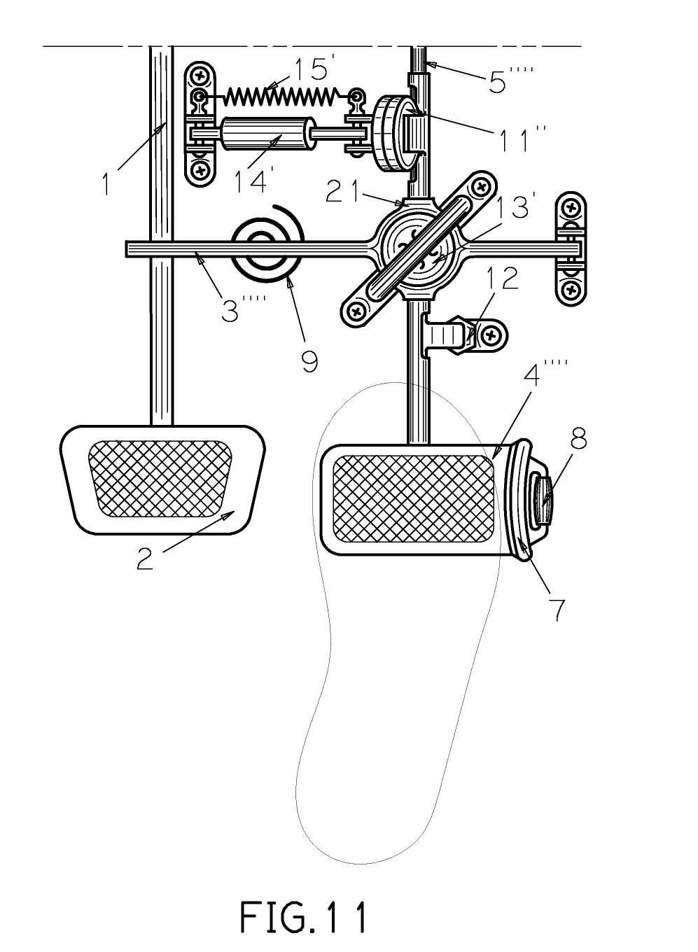

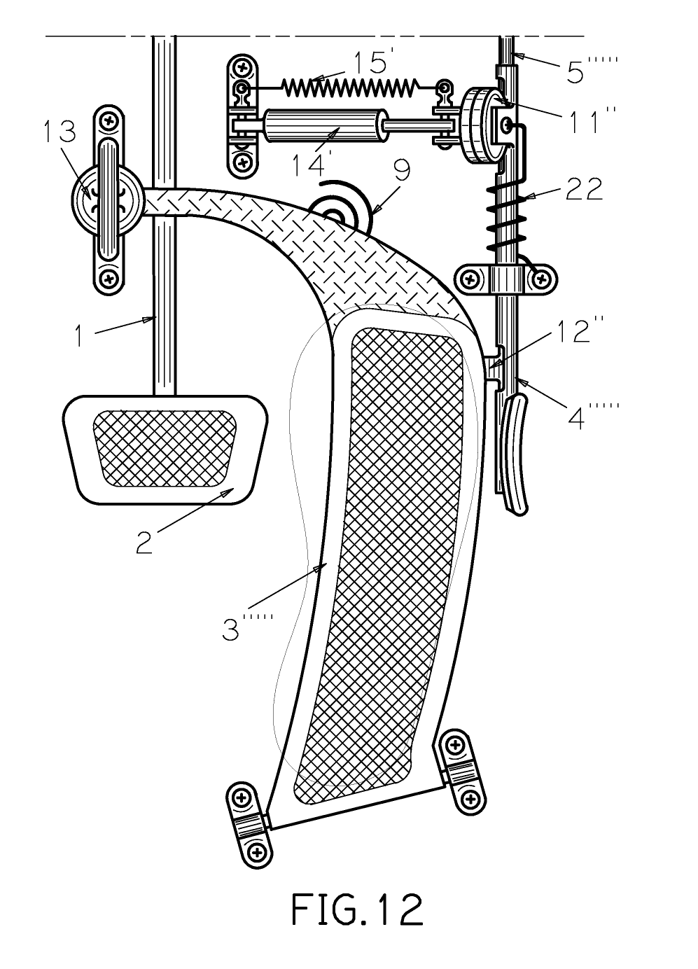

Referring to FIG. 6, the brake pedal detent (13) of the pedal assembly, shown in FIG. 4 and FIG. 12 or the modified brake pedal detent (13′) shown in FIG. 11, differs from the detent (11) shown in FIG. 5 in that, the upper part (17) is permanently and/or flexibly attached via a frame to the floor (19) in the space for the driver's feet and the detail (18) is permanently and/or flexibly attached to the brake pedal first part (3). The upper part (17) is an electromagnet receiving working electric current via cable (20).

Referring to FIG. 7, the stopping device (10) shown in FIG. 2, FIG. 3 and FIG. 14 limits the advance upward of the brake pedal first part (3). Said stopping device (10) is attached to the floor (19) in the space for driver's feet.

Referring to FIG. 8, the return spring (9) shown in FIG. 2, FIG. 3, FIG. 4, FIG. 11, FIG. 12, FIG. 13 and FIG. 14 returns the brake pedal first part (3) into initial position. The return spring (9) is attached to the floor (19) in the space for driver's feet.

Referring to FIG. 9, the stopping device (12′) shown in FIG. 4 disengages the acceleration pedal detent (11′), when the brake pedal first part (3′″) depressed down or the acceleration pedal first part (4′″) is excessively advanced transversely.

Referring to FIG. 10, stopping device (12) shown in FIG. 3, FIG. 11, FIG. 13 and FIG. 14 limits the advance for the acceleration of the acceleration pedal last part (5). The stopping device (12) is attached to the floor (19) in the space for driver's feet.

Referring to FIG. 11, the embodiment of the vehicle pedal controls is suitable for the inversion-eversion operation of the acceleration pedal and downward operation of the brake pedal by the driver's foot or feet. The stopping ledge (7) attached to the platform (4″″) prevents the driver's foot from getting outside the platform's edge going down at inversion motion of the driver's foot, for example, during prolong driving. A roller (8) prevents the platform (4″″) getting stuck in the floor. The acceleration pedal first part (4″″), which is springy or springy mounted, rotates in the bearing (21), which is set into the brake pedal first part (3″″). The acceleration pedal first part (4″″) is connected to the acceleration pedal last part (5″″) via the acceleration pedal detent (11″). The damping device (14′) together with the spring (15′) resists the fast clockwise rotation of the acceleration pedal last part (5″″) causing acceleration, but the counterclockwise rotation decreasing acceleration. If said clockwise rotation is excessively fast, then said resisting is excessively strong, so the acceleration pedal detent (11″) disengages and the acceleration pedal last part (5″″) is returned by the return spring (15′) into its initial position of smallest acceleration. If the angle of clockwise rotation of the acceleration pedal first part (4″″) is excessively advanced then the stopping device (12) stops the clockwise rotation of the acceleration pedal last part (5″″), the acceleration pedal detent (11″) disengages and the acceleration pedal last part (5″″) is returned by the return spring (15′) into its initial position of smallest acceleration. If the driver steps down harder than usual on the acceleration pedal first part (4″″), for example, misapplies the acceleration pedal instead of the brake one, then the brake pedal detent (13′) disengages, consequently the acceleration pedal first part (4″″) goes down and disengages the acceleration pedal detent (11″) by means of the stopping device (12), so the acceleration pedal last part (5″″) is returned by the return spring (15′) into its initial position of smallest acceleration, but the acceleration pedal first part (4″″) going down also pulls down the brake pedal first part (3″″) made as a lever, which pushes downward the brake pedal body (1), as a result, the vehicle brakes start working. But if released from the driver's foot pressure, the acceleration pedal first part (4″″) and the brake pedal first part (3″″) are returned by the return spring (9) into their initial positions, consequently, the acceleration pedal detent (11″) and the brake pedal detent (13′) engage—the vehicle pedal controls restore their efficiency immediately after the driver's foot has been removed. The advantage of this embodiment is the opportunity of levering of the driver's foot impact at the misapplication of the acceleration pedal.

Referring to FIG. 12 the embodiment of the vehicle pedal controls is suitable for the downward operation of the brake pedal and the transverse operation of the acceleration pedal by the driver's foot or feet, wherein the first part (4′″″) and the last part (5′″″) of the acceleration pedal is made coaxially rotating around an axis approximately parallel to the body (1) of the brake pedal and wherein the acceleration pedal is transversely operable though rotating around the axis. The brake pedal detent (13) together with the return spring (9) keeps the brake pedal first part (3′″″), loaded with the driver's foot, in the upper position, where the brake pedal first part (3′″″), hanging over the body (1) of the brake pedal, does not contact said body (1). Pushing the acceleration pedal first part (4′″″) to the right, the driver causes acceleration of the vehicle, as said first part (4′″″) turns, via the acceleration pedal detent (11″), the last part (5′″″) of the acceleration pedal, which directly connected to the throttle of the vehicle engine. But, excessively pushing the acceleration pedal first part (4′″″) to the right causes disengagement of the acceleration pedal detent (11″) by the stopping device (12″), which comes up against the back side of the brake pedal first part (3′″″). Upon said disengagement the acceleration pedal last part (5′″″) is returned by the return spring (15′) into its initial position of smallest acceleration. The damping device (14′) together with the spring (15′) resists the fast clockwise turn of the acceleration pedal last part (5′″″) causing acceleration. And, if said turn is excessively fast, then said resisting is excessively strong, so the acceleration pedal detent (11″) disengages and the acceleration pedal last part (5′″″) is returned by the return spring (15′) into its initial position of smallest acceleration. The damping device (14′) together with the spring (15′) does not resist the fast counterclockwise motion of the acceleration pedal last part (5′″″) decreasing acceleration. If the driver steps harder than usual on the brake pedal first part (3′″″), then the brake pedal detent (13) disengages, consequently the brake pedal first part hanging over the body (1) pushes downward said body (1) and turns counterclockwise the acceleration pedal last part (5′″″), via the stopping device (12″), as a result, the vehicle's brakes start working and the acceleration pedal last part (5′″″) returns into its initial position of smallest acceleration. But, if the brake pedal first part (3′″″) and the acceleration pedal first part (4′″″) have released from the driver's foot pressure, then they are returned into their initial positions, by the return spring (9) and (22), consequently the brake pedal detent (13) and the acceleration pedal detent (11″) engage again. In all, the pedal controls restore their efficiency immediately after the driver's foot has been removed.

Referring to FIG. 13, the embodiment of the vehicle pedal controls is suitable for the downward operation of pedals by the driver's foot or feet. The acceleration pedal first part (4″″″) is mounted with the return spring (9′) and the stopping device (12). Said first part (4″″″) contacts the brake pedal first part (3″″″) supported by spring (9). Said first part (3″″″) hangs over the brake pedal body (1) but contacts it, while the acceleration pedal first part (4″″″) is within the range of normal downward motion causing the acceleration of the vehicle. But, if the acceleration pedal last part (5″″″) advanced, via the detent (11) downward so deeply, for example, because of the misapplication, that said last part (5″″″) has been stopped mechanically by a stopping device (12) and the detent (11) has been disengaged, then the acceleration pedal last part (5″″″) is returned, by the return spring (9′), into the starting position of the smallest acceleration. The acceleration pedal first part, deeply advanced downward, lifts the end of the brake pedal first part (3″″″) made as a lever and the other end of said first part (3″″″) pushes down the brake pedal body (1)—the vehicle brakes start working. But, if the acceleration pedal first part (4″″″) has released from the driver's foot pressure, then it is returned into its initial position, by the return spring (9) acting via the end of the brake pedal first part (3″″″), consequently the acceleration pedal detent (11) engages again. In all, the pedal controls restore their efficiency immediately after the driver's foot has been removed. The advantage of this embodiment is the opportunity of levering of the driver's foot impact at the misapplication of the acceleration pedal.

Referring to FIG. 14, the embodiment of the vehicle pedal controls is suitable for the downward operation of any of two pedals by the driver's foot or feet. This embodiment is similar to that shown in FIG. 3, except for there has been added the emergency handle (23), which rises upward and is kept in its initial position by the spring (24). If pulled back, the emergency handle (23) pushes with its ledge (25) downward the first part (3″), consequently, disengages the detent (11) and via said first part (3″) pushes downward the body (1), and thus, starts braking. The emergency handle (23) may be pulled back by a person sitting next to the driver, when said person considers as a danger the driver's mental and/or physical condition and/or situation on the road and/or situation inside and/or outside the vehicle and/or perceives any other signal of danger inside and/or outside of the vehicle. Said pull back the emergency handle (23) may be considered as the mechanical signal to disengage the detent (11) and to put on the vehicle's brakes. The pedal controls restore their efficiency immediately after the emergency handle (23) has been released.

I claim:

1. A vehicle acceleration pedal, also known as an accelerator or a gas pedal, comprising a rigid body rotating around an axis or fulcrum and a platform attached to the body to accommodate a driver's foot, wherein the improvement comprises the vehicle acceleration pedal being suitable for the inversion-eversion operation of the pedal by the driver's foot.

2. A vehicle acceleration pedal in accordance with claim 1, wherein the ledge is attached to the edge of the platform and the ledge is suitable for preventing the driver's foot getting outside the platform's edge going down at inversion motion of the driver's foot.

3. A vehicle acceleration pedal in accordance with claim 1, wherein the platform overhangs the rigid body of a brake pedal and said platform is suitable to push said body downward, when said platform is under the eversive and/or downward impact by the driver's foot or feet.

4. A vehicle acceleration pedal in accordance with claim 3, wherein the rigid body is springy body or springy mounted body and being able to sag reversibly under the push downward by the driver's foot.

5. A vehicle control pedal comprising a rigid body rotating around an axis or fulcrum and a platform attached to the body to accommodate a driver's foot, wherein the improvement comprises the mechanical division of the pedal, at least, into two parts, namely: the first part and the last part, and the addition of a mechanical detent or detents holding the first part of the pedal, which is actuated by the driver's foot, in mechanical relation to the last part of the pedal, which actuates a device of the vehicle and cannot or can be actuated by the driver's foot, so that,
for the acceleration pedal or the accelerator or the gas pedal, if the detent is engaged, then the driver's foot mechanical impact being able to cause the acceleration of the vehicle and applied to the first part of the acceleration pedal is transmitted to the last part of the acceleration pedal, but said driver's foot mechanical impact is not transmitted to the last part of the acceleration pedal, if the detent is disengaged, and the last part of the acceleration pedal cannot be actuated directly by the driver's foot, either the detent is engaged or disengaged,
for the brake pedal, if the detent is engaged, then the driver's foot mechanical impact being able to cause braking of the vehicle and applied to the first part of the brake pedal is not transmitted to the last part of the brake pedal, but said driver's foot mechanical impact is transmitted to the last part of the brake pedal, if the detent is disengaged, and the last part of the brake pedal can be actuated directly by the driver's foot, either the detent is engaged or disengaged,
and wherein the release of any detent of any vehicle control pedal is made by the driver's foot mechanical impact applied to said pedal, at the time of a misapplication of said pedal and/or certain driver's mental and/or physical condition and/or situation on the road and/or situation inside the vehicle and/or a signal of danger, or the release of any detent is made by the signal to release.

6. A vehicle control pedal in accordance with claim 5, wherein the first part of the pedal and the detent are shared by the acceleration pedal and the brake pedal.

7. A vehicle control pedal in accordance with claim 5, wherein the signal of danger or the signal to release is generated inside the vehicle.

8. A vehicle control pedal in accordance with claim 7, wherein the signal of danger or the signal to release is generated outside the vehicle and transmitted to the vehicle.

9. A vehicle control pedal in accordance with claim 5, wherein any detent is of permanent holding capacity.

10. A vehicle control pedal in accordance with claim 9, wherein any detent comprises a permanent magnet.

11. A vehicle control pedal in accordance with claim 5, wherein any detent is of variable holding capacity.

12. A vehicle control pedal in accordance with claim 11, wherein any detent comprises an electromagnet.

13. A vehicle control pedal in accordance with claim 12, wherein any detent holding capacity is controlled by means of electric current by the vehicle's central processing unit and/or electric controls.

14. A vehicle acceleration pedal in accordance with claim 5, wherein the last part of the pedal comprises a device damping the driver's foot mechanical impact to increase acceleration of the vehicle.

15. A vehicle acceleration pedal in accordance with claim 14, wherein the damping device is controlled by means of electric current by the vehicle's central processing unit and/or electric controls.

16. A vehicle acceleration pedal in accordance with claim 5, wherein the last part of the pedal comprises a device resisting mechanically to the driver's foot mechanical impact for increasing the acceleration of the vehicle.

17. A vehicle acceleration pedal in accordance with claim 16, wherein the resisting device is controlled by means of electric current by the vehicle's central processing unit and/or electric controls.

18. A vehicle acceleration pedal in accordance with claim 5, wherein the last part of the pedal comprises a device stopping mechanically further advance of said last part at a certain position.

19. A vehicle acceleration pedal in accordance with claim 18, wherein the certain position may be varied.

20. A vehicle acceleration pedal in accordance with claim 19, wherein the certain position is being varied by means of electric current by the vehicle's central processing unit and/or electric controls.
